(19) United States
(12) Patent Application Publication
(10) Pub. No.: US 2008/0159838 A1
(43) Pub. Date: Jul. 3, 2008

(54) Cargo area extending foldable loading ramp

(76) Inventor: Bradley Yates Sherer, Chapin, SC (US)

Correspondence Address: MICHAEL A. MANN;NEXSEN PRUET, LLC, PO DRAWER 2426, COLUMBIA, SC, 29202-2426, US

(21) Appl. No.: 11/711,952

(22) Filed: Feb. 27, 2007

Related U.S. Application Data
(60) Provisional application No. 60/789,346, filed on Apr. 5, 2006.

(51) Int. Cl. B60P 1/00

(52) U.S. Cl. 414/537

(57) ABSTRACT

A three-section foldable loading ramp extends a pick-up truck's cargo area to accommodate heavy and lengthy items. The first or frame section of the present loading ramp installs onto the existing tailgate slip hinges in place of the tailgate without tools or modification of the vehicle. Upper and lower ramp sections are pivotally connected to each other and to the frame section in a similar manner. An arm carried by the first frame section pivots down onto the vehicle's hitch for additional support for the ramp; two legs pivot down from the upper ramp to engage the ground provide further support. The surface of ramp is covered with expanded metal or metal mesh to provide traction in the loading configuration and rearward visibility for the drive in the loaded configuration, with reinforcing added where the load will engage the ramp surface.

### CROSS REFERENCE TO RELATED PATENTS

The priority benefit of U.S. provisional patent application Ser. No. 60/789346, filed Apr. 5, 2006, is claimed.

### BACKGROUND OF THE INVENTION

The present invention relates to a loading ramp which is designed to replace the existing tailgate and extend the usable cargo area without other modification to the vehicle, thereby allowing the safe loading and unloading of heavy and lengthy items on to the truck cargo area.

Over the years, the pick-up truck has evolved from a rugged vehicle into a refined vehicle offering both practical and comfortable driving conditions, while still being useful for the movement of cargo. Pickup trucks often have the same status and the same features as many luxury cars, including seating for four passengers. Because of the expense of these new trucks, it is not uncommon for them to be the sole means of transportation for many families. Because the car manufacturers view this development as a way to capitalize on an already popular vehicle, the majority of trucks produced today have larger interiors, but at the expense of a shortened cargo area. The reduced cargo bed length poses a problem when transporting longer items such as large street motorcycles, lawn equipment, golf carts, or any item with a length in excess of six feet.

In addition to the problem of the shorter bed length, getting these large items into the truck bed when they are too heavy for manual lifting is another problem. The most common way to get these items in the cargo area was the use of one narrow ramp or the combination of two narrow ramps for vehicles with four wheels. Attempting to move a large heavy object up a short narrow ramp creates a difficult and potentially dangerous situation. For example, a HARLEY DAVIDSON® motorcycle may weigh up to 800 lbs. and be very expensive to repair if damaged during loading or unloading using a single narrow ramp.

The potential for damage is a real one. Many narrow ramps available today do not attach to the vehicle and simply rest on the factory-installed tailgate. These ramps can easily slip off the tailgate with dangerous and costly results. Furthermore, tailgates are not designed to handle the weight produced by these single narrow ramps pushing down on them, with the attendant potential for damage to the tailgate and perhaps the cargo area. Moreover, once the item is loaded, the ramp must be disconnected and stored in the cargo area for removal of the item at the next location, so valuable cargo space is used unnecessarily and the ramp itself may damage the cargo during transit.

The present invention overcomes these disadvantages commonly associated with new shorter cargo area trucks and the use of conventional ramps currently available for loading and unloading of items.

A search of prior art reveals no tailgate system that uses the existing vehicle's tailgate hardware and extends the usable cargo area while deriving a portion of its structural support from the existing trailer hitch or providing a safe folding ramp that does not always consume cargo area during storage while driving.

There are several prior art patents that teach various truck bed extensions. U.S. Pat. No. 4,735,454 issued to John N. Bernard discloses a ramp bi-folding that is interchangeable with the factory tailgate. This ramp may come in contact with the vehicle's rear bumper, causing damage and may not allow the angle intended by the inventor.

U.S. Pat. No. 5,988,725 issued to Leslie W. Cole discloses a three-section, foldable ramp that serves as an end gate upon storage. This ramp, however, when serving as an end gate, consumes usable cargo area.

U.S. Pat. No. 5,156,432 issued to Dennis M. McCleary describes a ramp that replaces the existing tailgate, and is bi-folding and covered with metal mesh. This ramp consists of only two ramp panels of a short length, which would produce a very steep and potentially dangerous angle when loading or unloading.

U.S. Pat. No. 6,120,081 issued to Robert J. Collins discloses a three-section, foldable ramp with a metal mesh deck that uses tailgate hardware and serves as an end gate when in the stored position. This ramp, while having three sections for added length, lacks support in the loading position by any source other than hinge assemblies. Therefore, it is susceptible to failure during the loading of heavy items.

U.S. Pat. No. 4,944,546 issued in the name of William K. Keller discloses a foldable, three-section ramp permanently mounted to the rear of a truck serving as an end gate when stored. This device is permanently mounted and requires significant vehicle modification.

### SUMMARY OF THE INVENTION

The present invention consists of a three-section, folding loading ramp for cargo that forms a ramp when the three sections are attached to the vehicle and connected together. When unfolded and in the loading configuration, the present loading ramp facilitates moving a load into the bed of the vehicle. When folded to its loaded configuration, the ramp serves as a tailgate for an expanded cargo area. The ramp may also be folded to a third or storage configuration onto the bed when no cargo is being moved to allow better vision and easy parking. The loading ramp is attached to the truck in place of the truck's pre-existing tailgate in a matter of seconds without the use of tools and without modification of either the existing tailgate-holding hardware or the vehicle.

To use the loading ramp from the storage position in the bed, simply lift the unit to the upright or loaded configuration and secure the arm to the hitch by way of one quick disconnect pin.

From the upright or loaded configuration, the two ramp sections that comprise the ramp can be unfolded easily to the loading configuration by removing a locking pin that otherwise secures them in the loaded configuration. The first section, or frame section, is supported by the vehicle both from its bed in the same manner as the tailgate but also by a pivoting arm member that locks to the vehicle's hitch. For additional support beyond that provided by the frame section, the first or upper ramp section rests on pivoting, ground-engaging leg members; the second or lower ramp section derives its support from the upper ramp section and from the ground.

Accordingly, it is one objective of the present invention to extend the usable cargo area of the vehicle. It is another objective of the present invention to provide a new tailgate system that is easy to use, operates as both a ramp and tailgate, and, as a ramp, is capable of sustaining heavy loads. It is another objective to provide a ramp, that, when stored, does not restrict vision or permanently consume cargo area during vehicle operation. It is still another objective to provide a loading ramp which can be easily installed and removed from a typical pickup truck with no tools or modifications to the truck. These and other objectives of the present invention will become apparent upon review of the attached specifications and drawings.

### BRIEF DESCRIPTION OF THE DRAWINGS

FIG. 1 is a side view of the loading ramp in the loading configuration, with the lower ramp section shown in phantom to illustrate a step in the unfolding of the present loading ramp to the loading position, according to a preferred embodiment of the present invention.

FIG. 2 is a side view showing the loading ramp of FIG. 1 in a configuration intermediate to loading and loaded configurations, with the ramp sections shown in phantom in the loaded configuration.

FIG. 3 shows a side view of the loading ramp of FIG. 1 in the stored configuration.

FIG. 4 shows an end view of the loading ramp of FIG. 1 in the loading configuration.

FIG. 5 is a top view of the loading ramp of FIG. 1, in the loading configuration.

### DETAILED DESCRIPTION OF THE INVENTION

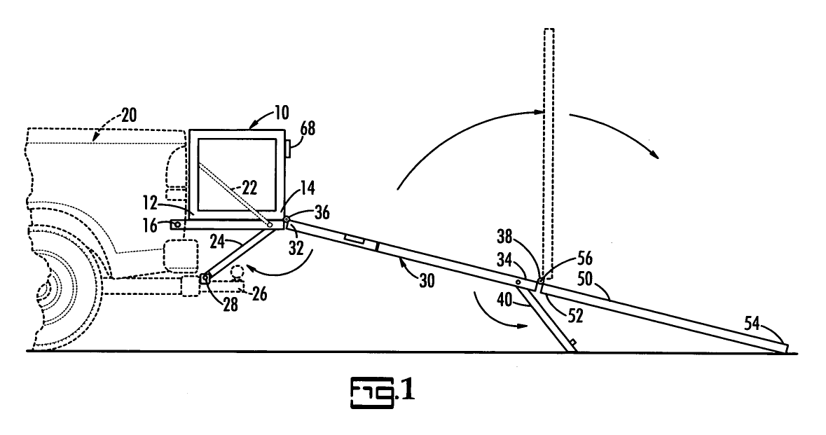

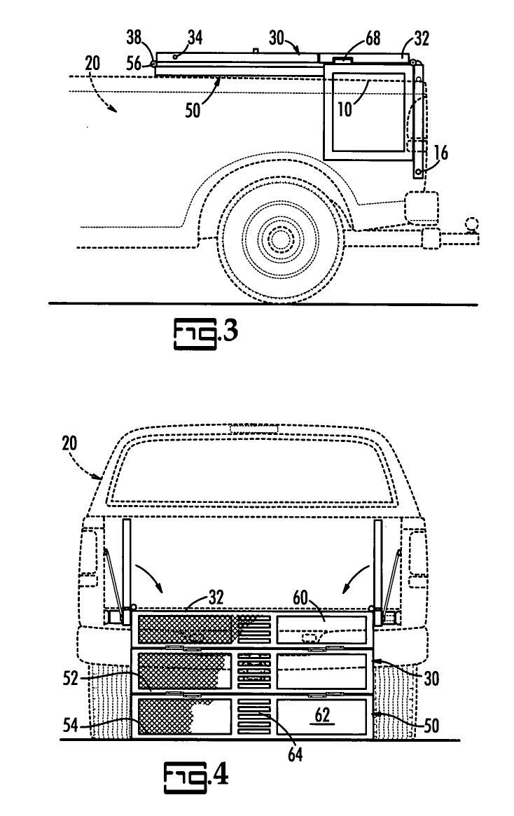

Referring now to FIGS. 1-5, the invention has three main components, frame section 10, upper ramp section 30, and lower ramp section 50. All main components are preferably constructed of materials of sufficient rigidity and strength and formed in such a way as to safely load objects of upwards of 1000 pounds and more, depending on the load rating of the vehicle with which the present loading ramp is intended to be used.

The pre-existing, factory tailgate (not shown) is first removed, which can be done without tools simply by sliding the open tailgate sideways and lifting it clear of slip hinges 18 (FIG. 5) on a vehicle 20. Typically, there will be at least two hinges per tailgate.

Frame section 10 has a proximal end 12, when viewed from the perspective of the driver, and an opposing distal end 14. Proximal end 12 of frame section 10 has a first slip hinges 16 on proximal end 12 that slidably engage the slip hinges (not shown) on vehicle 20, such as a pickup truck, and that are otherwise intended for a factory tailgate and would receive the slip hinges of the tailgate. Frame section 10 is supported in part from above by the factory tailgate straps 22.

Frame section 10 is also supported from below by pivoting arm member 24 (FIG. 1), which pivots downward from the underside of frame section 10 into place on top of a tow hitch 26 carried by vehicle 20 and is secured thereto by a pin 28, preferably a quick release hitch pin.

Upper ramp section 30 has a proximal end 32 and a distal end 34. Proximal end 32 has first slip hinges 36 and distal end 34 has second slip hinges 38. The proximal end 32 of upper ramp section 30 (FIG. 1) then can be attached to frame section 10 by sliding slip hinge 36 onto first slip hinge which are secured to frame section 10 preferably by welding.

A pair of pivoting leg members 40 (FIG. 1) carried by distal end 34 of upper ramp section 30 may be pivoted downward to engage the ground to provide additional support to upper ramp section 30.

A lower ramp 50 is attached to upper ramp 30 to complete the present loading ramp. Lower ramp 50 has a proximal end 52 and an opposing distal end 54. Proximal end 52 carries a first slip hinge 56 that can be attached to second slip hinge 38 of upper ramp 30's distal end 34.

The folding ramp as shown in FIG. 1 is then fully installed on the vehicle 20 and unfolded from the upright or loaded configuration to the loading configuration as shown. Arrows in FIG. 1 illustrate the direction lower ramp 50, and leg members 40 are pivoted to unfold the present loading ramp from the upright or loaded configuration wherein lower ramp 50 is folded against upper ramp 30 to the loading configuration with support from hitch 26 and the ground.

So-called slip hinges are well-known. These hinges have two parts rather than the typical three parts of a standard door hinge (rod and two plates with interleaving cylindrical fingers). Both hinges include plates for fastening the hinge permanently to a structure (in the present case, either to one of the main components of the loading ramp). A first slip hinge has a rod held in spaced relation to its plate and extending parallel to the axis the hinge will pivot about, and the other slip hinge has a hollow cylinder dimensioned and held by its plate in such a way that it can be slipped over the rod and pivoted about the rod of the first slip hinge. Also, frame section 10, upper ramp 30 and lower ramp 50 will likely have plural slip hinges on each end for good alignment of the sections. Other types of hinges will work equally well but slip hinges are preferred because they require no tools to remove or join the sections.

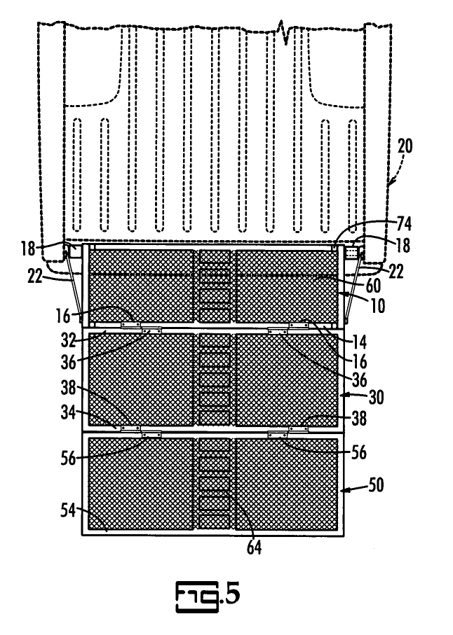

The frame section 10, upper ramp section 30 and lower ramp section 50 are preferably made of metal, most preferably tubular metal, such as square tubular steel because of its high strength-to-weight ratio, ready availability, ease of manufacturing and low cost. Other metals, such as aluminum tubing will also be suitable. Upper and lower ramp sections 30, 50 are for use in driving a motorcycle or lawn tractor or other large, heavy object up into the bed of the truck. The surfaces 60, 62, of upper and lower ramp sections 30, 50, are preferably made of expanded metal or other perforated surfacing or grid-like material, with reinforcing added to key areas as needed, in order to hold the anticipated load where it most likely will be concentrated. For example, in FIG. 4, reinforcing 64 is applied in the center because the wheels of a motor cycle will engage the center of upper and lower ramp sections 30, 50, and that is where the weight of the motorcycle will be concentrated. For lawn tractors, reinforcing may be made in two spaced apart rows where the wheels of lawn tractors will run.

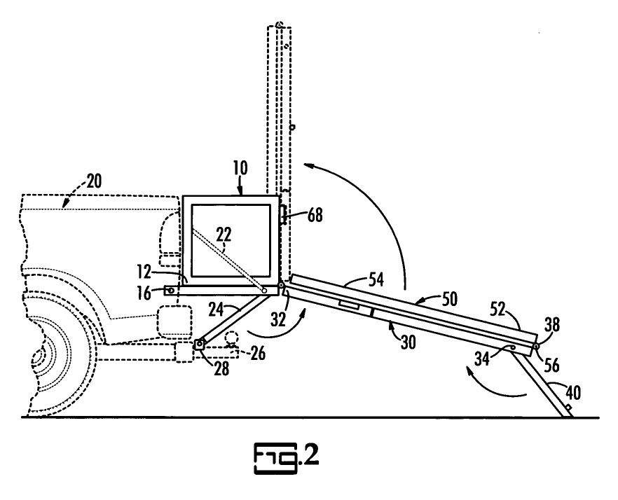

Expanded metal, and equivalent, not only reduces weight without compromising significantly on strength compared to solid metal but also makes it easier for the driver to see through the present ramp when the ramp is in its upright or loaded configuration as seen in FIG. 2. In the loaded configuration, folded upper and lower ramps sections 30, 50 of the present ramp serve as a tailgate, and are somewhat taller than the vehicle's factory tailgate. Accordingly being able to see through upper and lower ramp sections 30, 50, is important. Other surface materials of sufficient strength will also be suitable but are preferably made with perforations, holes or openings so that the driver of vehicle 20 can see when looking rearwardly.

To move the present loading ramp from the loading configuration to the upright or loaded configuration, lower ramp section 50 (FIG. 2) is folded 180 degrees to rest on upper ramp section 30. Upper and lower ramp sections 30, 50, are now pivoted together, in accordance with the direction of the arrow in FIG. 2, up and around upper ramp section 30's first slip hinges 36 to the upright or loaded configuration, and secured by a slide pin 68, on each side. Leg members 40 (upon lifting of upper and lower ramp sections 30, 50) swing down toward upper ramp section 30 and are secured with a quick disconnect hitch pin (not shown). The present folding ramp is now in the upright or loaded configuration for transport.

It will be understood that minute changes to the configuration and proportions can be made to accommodate the various types of tailgate mounting hardware and various types of pickup without departing from the spirit and scope of the present invention.

What is claimed is:

1. A loading ramp, for use with a vehicle ordinarily having a tailgate and tailgate slip hinges, said tailgate of said vehicle having been removed from said slip hinges, said ramp comprising:
a frame section having first hinges and second hinges, said first hinges for hingedly connecting said frame section to said tailgate slip hinges;
an upper ramp section having a proximal end, an opposing distal end, and first hinges carried by said proximal end of said upper ramp section, said first hinges of said upper ramp section being hingedly connectable to said second hinges of said frame section, said upper ramp having second hinges carried by said distal end of said upper ramp; and
a lower ramp section having a proximal end, an opposing distal end, and first hinges carried by said proximal end of said lower ramp, said first hinges of said lower ramp section being hingedly connectable to said second hinges of said distal end of said upper ramp, so that said frame section, said upper ramp section and said lower ramp section can be hingedly connected together to form a loading ramp, said ramp having a loading configuration, an upright or loaded configuration, and a storage configuration, said distal end of said lower ramp engaging the ground when said loading ramp is in said loading configuration, said upper ramp section and said lower ramp section being folded together when said loading ramp is in said loaded configuration.

2. The loading ramp as recited in claim 1, wherein said vehicle has a hitch, and wherein said loading ramp further comprises an arm member pivotally carried by said loading ramp, said arm member being dimensioned to pivot from said loading ramp to said hitch of said vehicle and attaching, whereby said arm member derives support for said loading ramp from said hitch.

3. The loading ramp as recited in claim 2, wherein said arm member is pivotally attached to said distal end of said frame 10.

4. The loading ramp as recited in claim 2, further comprising a locking pin for attaching said leg member to said hitch of said vehicle.

5. The loading ramp as recited in claim 1, further comprising leg members pivotally carried by loading ramp, said leg members being dimensioned to engage the ground when said loading ramp is in said loading configuration.

6. The loading ramp as recited in claim 5, wherein said leg members are carried by said distal end of said upper ramp section.

7. The loading ramp as recited in claim 1, wherein said first and second hinges of said upper ramp section and said first hinges of said lower ramp section are slip hinges.

8. The loading ramp as recited in claim 1, wherein said frame section has a proximal end and a distal end, said first hinges being carried by said proximal end of said frame section and said second hinges being carried by said distal end.

10. The loading ramp as recited in claim 1, wherein said upper ramp section and said lower ramp section are framed of tubular steel and covered with expanded metal.

11. The loading ramp as recited in claim 10, wherein a load to be loaded into said vehicle by said loading ramp has wheels, and wherein said upper ramp section and said lower ramp section are reinforced at locations wherein said wheels engage said upper and said lower ramp sections.

12. The loading ramp as recited in claim 1, wherein said upper ramp section and said lower ramp section have holes formed therein so that, when said loading ramp is in said loaded configuration, a driver of said vehicle sees therethrough when looking rearwardly.
